(19) United States
(12) Patent Application Publication
(10) Pub. No.: US 2007/0012333 A1
(43) Pub. Date: Jan. 18, 2007

(54) FLOSS-O-MAT

(76) Inventor: Louis Charles D'Aquila, Sayville, NY (US)

Correspondence Address: Louis C. D'Aquila, 14 Nancy Drive, Sayville, NY, 11782, US

(21) Appl. No.: 11/183,095

(22) Filed: Jul. 16, 2005

(51) Int. Cl. A61C 15/00

(52) U.S. Cl. 132/325

(57) ABSTRACT

FLOSS-O-MAT is an improvement on the automated dental floss dispensing apparatus based on and described in the Ippisch model, U.S. Pat. No. 5,645,206 dated Jul. 8, 1997. The changes and improvements to the Ippisch patent as well as the intended use and rational for intended locations and placement of this apparatus are described below.

The Ippisch patent claims that it can dispense waxed and un-waxed dental floss and other cordage for dental or medical use. It does not however, claim that the same can dispense “sterile” dental floss or other medical and dental cordage. References to sterility are however implied in the information included in the “BACKGROUND OF THE INVENTION” column 1 lines 20 thru 56. The assumption of any such claim according to the Ippisch Model as described would be misleading and untrue, if not impossible, since the non-sterile air and the dispensing mechanism inside of the housing, i.e. the rollers 26, cutter 22, dispensing receptacle 16, discharge aperture 18, spool of floss 19, dispensing aperture 20 with which the floss 12 and 19 come into contact are not being maintained in a sterile environment according to the Ippisch model. Thusly, any sterile floss or medical/dental cordage loaded into the “unsterile” environment of the Ippisch apparatus would be rendered unsterile after only a short period of time. In order to remedy this situation, Floss-o-Mat contains an internal sterilization system.

This patent application claims the benefit of the filing date of my earlier-filed Provisional Patent Application No. 60/664,460 filed on Mar. 24, 2005.

### REFERENCES CITED/CROSS-REFERENCED

U.S. Patent documents

U.S. Pat. No. 5,645,206 Jul. 8, 1997 Ippisch . . . 225/10 and those cited therein.

### BACKGROUND AND INTENDED USE

An automated apparatus for the dispensing of sterile waxed or un-waxed dental floss and other cordage or ligatures may be used solely as a dental floss dispenser and may be located in but are not limited to public and private places including medical and dental offices, restrooms of restaurants, household and hotel bathrooms. For the dispensing of other medical and dental cordage, this apparatus may be used in a variety of medical and dental facilities. For locations in public facilities, as well as in medical environments, the assurance of sterility is a primary concern in order to assist in the control of the spread of infectious diseases. Therefore, the inclusion of a sterilization system similar to the one described herein is a necessity. The FLOSS-O-MAT contains such a system.

### STERILIZATION SYSTEM

This system may be similar to any used in the medical, food processing, agricultural or other fields where the sterilization of a product is the goal. It requires sufficient ultra-violet light or other means to effectively illuminate or eradiate the entire spool of dental floss or cordage and all contact hardware, as well as the air itself inside of the housing.

### SUMMARY OF THE INVENTION

Floss-o-Mat is an improvement of the Ippisch invention, U.S. Pat. No. 5,645,206, Jul. 8, 1997 by the addition of an internal sterilization system.

### DESCRIPTION OF PICTURES

The areas and mechanical parts (highlighted and circled in Drawing 2) to be considered with regard to the claim of a “sterile” environment in the apparatus described as Floss-o-Mat are:

| | |
|---|---|
| Interior of the housing | 10 |
| Leading end of dental floss | 12 |
| Dispensing receptacle | 16 |
| Discharge aperture | 18 |
| Spool of floss | 19 |
| Dispensing aperture | 20 |
| Cutter | 22 |
| Rollers | 26 |

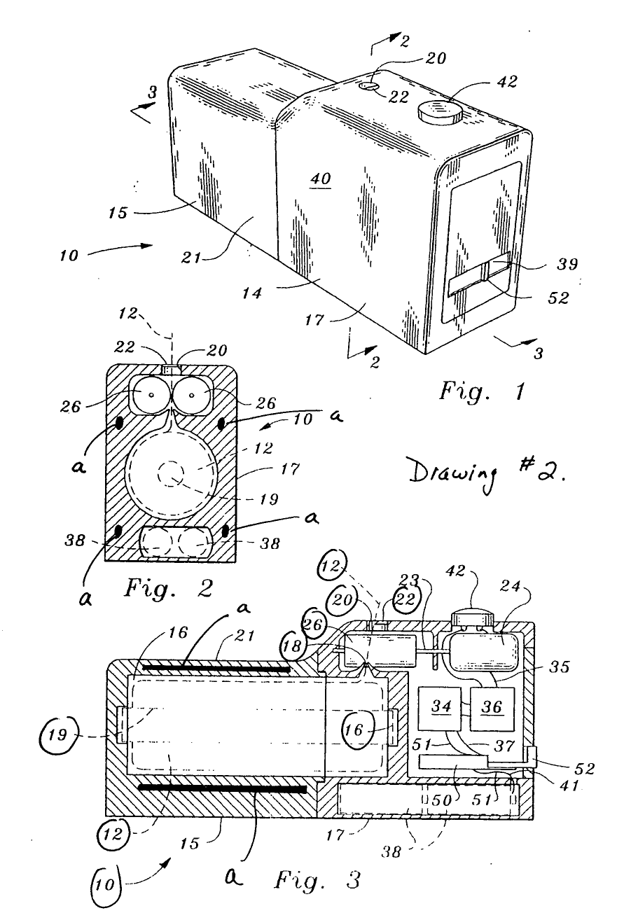

Drawings 1 & 2, FIGS. 1, 2 and 3 are taken from the Ippisch model U.S. Pat. No. 5,645,206 showing both internal and external views of the same apparatus. Drawing 1 shows the Ippisch model with no additions. Drawing 2 shows the locations of the proposed sterilization system—in this case, ultra-violet lights “a”. The inclusion of any sterilization system would have to be made to fit inside of the existing-sized housing or the housing could be enlarged if necessary in order to accommodate the sterilization system. In either case, further adjustments to the dimensions of the internal mechanisms might be necessary for correct mechanical functioning of the apparatus.

1. Floss-o-Mat, as described and based on the Ippisch U.S. Pat. No. 5,645,206, can dispense “sterile” dental or other medical cordage when a sterilization system is included in the housing of the apparatus and the sterilization medium sufficiently comes in contact with all essential parts of the internal mechanism. This is achieved by the introduction of an ultra-violet light (UV light) “a” or other sterilization system into the housing 10 of the dispenser for the purpose of continuous sterilization of all sides of the spool of dental floss, all mechanical parts, as well as the air itself inside of the dispenser, coming into contact with the floss or other cordage contained therein before dispensing.
